(19) United States
(12) Patent Application Publication
(10) Pub. No.: US 2025/0330357 A1
(43) Pub. Date: Oct. 23, 2025

(54) MIXED GENERATION PREAMBLE TRANSMISSION

(71) Applicant: MaxLinear, Inc., Carlsbad, CA (US)

(72) Inventor: Sigurd Schelstraete, Menlo Park, CA (US)

(73) Assignee: MaxLinear, Inc., Carlsbad, CA (US)

(21) Appl. No.: 19/186,480

(22) Filed: Apr. 22, 2025

Related U.S. Application Data
(60) Provisional application No. 63/637,255, filed on Apr. 22, 2024.

(51) Int. Cl. H04L 27/26; H04L 1/00; H04L 5/00

(52) U.S. Cl. CPC H04L 27/2613; H04L 1/0003; H04L 1/0009; H04L 5/0007

(57) ABSTRACT

An access point may include a processing device. The processing device may generate, at the AP, a transmission including a preamble including a physical layer (PHY) version identifier (ID) defined by a first Institute of Electrical and Electronics Engineers (IEEE) 802.11 standard. The processing device may generate, at the AP, the transmission including the preamble including one or more signaling bits defined by a second IEEE 802.11 standard. The access point may include a transceiver. The transceiver may send, at the AP to a station (STA), the transmission including the preamble.

### RELATED APPLICATION

This application claims the benefit of U.S. Provisional Application No. 63/637,255, filed Apr. 22, 2024, the disclosure of which is incorporated herein by reference in its entirety.

The examples discussed in the present disclosure are related to communications technology, and more specifically, to mixed generation preamble transmission.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi®. IEEE 802.11 may be a packet-based protocol. A physical layer protocol data unit (PPDU) may include preamble fields and data fields. The preamble field may include transmission vector format information.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, an access point (AP) may include a processing device. The processing device may generate, at the AP, a transmission including a preamble including a physical layer (PHY) version identifier (ID) defined by a first IEEE 802.11 standard. The processing device may generate, at the AP, the transmission including the preamble including one or more signaling bits defined by a second IEEE 802.11 standard. The access point may include a transceiver. The transceiver may send, at the AP to a station (STA), the transmission including the preamble.

In some examples, an access point may include a processing device. The processing device may generate, at the AP, a first transmission including a first preamble including a PHY version ID defined by a first IEEE 802.11 standard. The access point may include a transceiver. The transceiver may send, from the AP to a STA, the first transmission and the second transmission.

In some examples, an access point may include a processing device. The processing device may receive, at the AP from a first station, a transmission including a preamble including a PHY version ID defined by a first IEEE 802.11 standard. The preamble may include one or more signaling bits defined by a second IEEE 802.11 standard.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example physical layer protocol data unit (PPDU) format for IEEE 802.11be.

FIG. 2 illustrates an example PPDU format for IEEE 802.11be.

FIG. 3 illustrates an example user information field for non-multi-user multiple-input multiple-output (MU MIMO).

FIG. 4 illustrates an example user information field for non-MU MIMO.

FIG. 5 illustrates an example user information field for MU MIMO.

FIG. 6 illustrates an example user information field.

FIG. 7 illustrates an example of equal modulation and unequal modulation signaling.

FIG. 8 illustrates an example of modulation and coding scheme (MCS) signaling.

FIG. 9 illustrates an example of encoding.

FIG. 10 illustrates an example of MCS encoding.

FIG. 11 illustrates an example of MCS encoding.

FIG. 12 illustrates an example user information field.

FIG. 13 illustrates an example process flow of an access point used for mixed generation preamble transmission.

FIG. 14 illustrates an example process flow of an access point used for mixed generation preamble transmission.

FIG. 15 illustrates an example communication system.

FIG. 16 illustrates a diagrammatic representation of a machine in the example form of a computing device within which a set of instructions, for causing the machine to perform any one or more of the methods discussed herein, may be executed.

### DESCRIPTION

Starting with the development of the extremely high throughput (EHT) amendment to the IEEE 802.11 standard, also referred to as the IEEE 802.11be (“11be”) amendment, a Wi-Fi® preamble format was defined that was intended to be forward-compatible.

Specifically, this means that the preamble for the 11be amendment (and the preamble of any Wi-Fi® generation that is defined after the 11be amendment) may meet the following criteria: (a) the L_LENGTH value in the legacy signal (L-SIG) field may be a multiple of 3 (L_LENGTH mod 3=0); (b) the preamble may have a repeated L-SIG field (RL-SIG) to help identify it as an 11be (and later) preamble; (c) the universal signal (U-SIG) field may contain version independent fields, whose meaning and location may be the same for Wi-Fi versions (starting from 11be); (d) the specific Wi-Fi version may be identified by the PHY version Identifier (being one of the version independent fields); (e) 11be may be identified as PHY version ID=0; and (f) the U-SIG field may contain version dependent fields, which may be specific to the Wi-Fi generation identified by the PHY version and need not be the same for every generation of Wi-Fi.

Moreover, the 11be amendment has left a number of reserved bits in the various preamble fields, which may be used to make incremental changes to the functionality of the 11be amendment.

The 802.11bn amendment (Enhancements for Ultra High Reliability) may be the first generation of Wi-Fi® to be defined after the concept of the forward-compatible preamble that was introduced in 802.11be. The use of the forward-compatible preamble concept when defining the preamble for 11bn has not been developed.

Unlike 11be, 11bn is more “incremental” in nature. 11be introduced a number of features that were a break with the previous PHY/MAC generation of Wi-Fi (11ax), such as multi-link operation, multiple resource unit (MRU), new bandwidths and modulations, puncturing, and the like. These changes motivated a different preamble design.

While 11bn may introduce features that are not compatible with 11be (distributed resource unit (RU), multi access point (M-AP) operation, and the like), the operation of an 11bn transceiver may be similar to the transceiver of an 11be transceiver. For instance, transmission of a regular single user (SU) physical layer protocol data unit (PPDU) may not use the features that 11bn may define. In that case, the waveform of the data field of the SU PPDU may be similar between 11be and 11bn.

In an example that involves the transmission of an SU PPDU, the 11be preamble may carry PHY-related parameters for the PPDU so that the receiver can process the received PPDU accordingly. Among other things, the preamble may contain information on the MCS, coding type, bandwidth, number of spatial streams, and the like.

11bn may add to the possible choices for e.g., MCS, coding, and the like, but may not use these additional options all the time. Consequently, 11bn may send a transmission that uses values that were already available in 11be. In such a case, the IEEE 802.11 standard may provide multiple ways to send the same transmission. This duplication may be omitted. The difference between the transmitted packets may be the PHY version ID contained in the U-SIG field; the data field may be identical.

One practical issue with such duplication is that the 11bn format may be validated separately in Wi-Fi certification and testing programs, even when 11bn uses a mode or configuration that may be covered by 11be, which may result in additional testing and validation time.

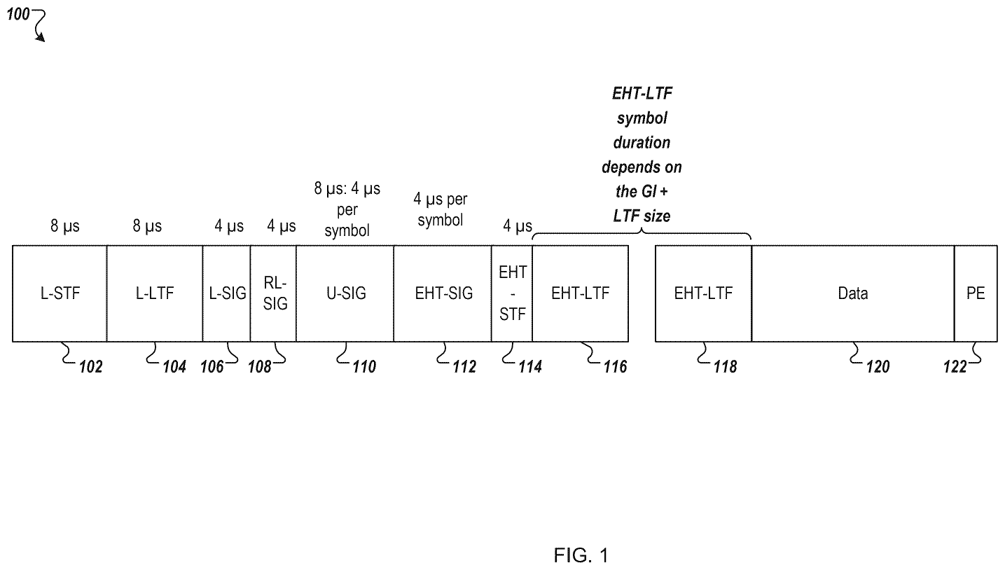

FIG. 1 illustrates an example preamble structure 100. The preamble may include one or more of: a legacy short training field (L-STF) 102 which may have a duration of about 8 μs; a legacy long training field (L-LTF) 104 which may have a duration of about 8 μs; an L-SIG 106 which may have duration of about 4 μs; an RL-SIG 108 which may have a duration of about 4 μs; a U-SIG 110 which may have a duration of about 8 μs, or 4 μs per symbol; an extremely high throughput signal field (EHT-SIG) 112 which may have a duration of about 4 μs per symbol; an extremely high throughput short training field (EHT-STF) 114 which may have a duration of about 4 μs; an extremely high throughput long training field (EHT-LTF) 116, 118 which may have a symbol duration that may depend on the guard interval (GI) and long training field (LTF) size; data 120 which may have a variable duration; and a packet extension (PE) field 122 which may have a variable duration. The preamble structure 100 may be used for an extremely high throughput multi-user (EHT-MU) transmission.

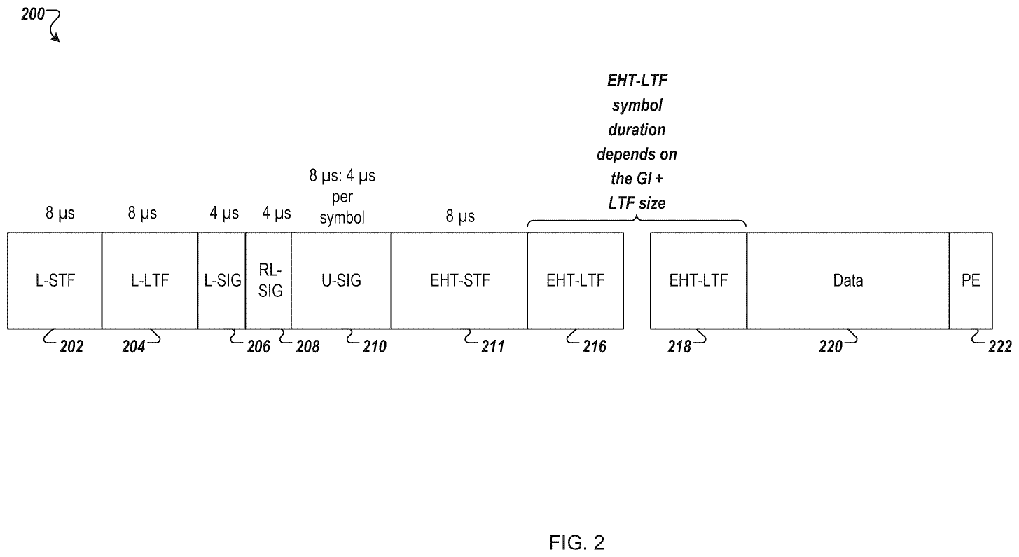

FIG. 2 illustrates an example preamble structure 200. The preamble may include some of the same fields that are present in FIG. 1 including one or more of: L-STF 202 which may have a duration of about 8 μs; L-LTF 204 which may have a duration of about 8 μs; L-SIG 206 which may have a duration of 4 μs; RL-SIG 208 which may have a duration of 4 μs; U-SIG 210 which may have a duration of 8 μs or 4 μs per symbol; EHT-LTF 216, 218 which may have a symbol duration that may depend on the GI and LTF size; data 220 which may have a variable duration; or PE 222 which may have a variable duration. The preamble structure 200 may include EHT-STF 211 which may have a duration of about 8 μs. The preamble structure 200 may be used for an extremely high throughput trigger based (EHT-TB) transmission.

To avoid duplication, one approach may be: an 11bn transmission that uses functionality that is already available in 11be may use the 11be format to send the frame. In particular, such a transmission may use PHY Version ID=0 (i.e., the 11be value) and the 11be-defined signaling for conveying PHY parameters in the preamble.

There are also aspects and 11bn features that may not exist in 11be. The PHY Version ID may be used to distinguish those transmissions, but there is also the option of using (some of) the reserved bits currently defined in 11be. These reserved bits could be used to add signaling for features that are unknown to 11be systems. The use of reserved bits may be similar to the use of a new PHY version ID value.

Implementing the principle stated above makes it possible to focus the design of the 11bn preamble on additional features, without being constrained by accommodating “legacy” and “additional” features into a single preamble. It also makes it possible to keep certification limited to any additional features or modes that may be defined in 11bn, without “re-validating” legacy behavior in a new certification program.

In some examples, 11bn may use a mix of PHY Version ID value 0 and a defined value for PHY Version ID (e.g., 1) when sending frames. This value may change on a per-PPDU basis. The PHY version IDs may be associated with reserved bits (e.g., available reserved bits for PHY Version ID=0).

Given the number of modes that may be contained in 11be and the additional modes that may be defined in 11bn, signaling for 11bn modes in the limited number of bits that is available in the preamble may be considered. Partitioning the modes into a set of modes that can be signaled with PHY Version ID=0 and an (additional) set of modes that may be signaled with PHY Version ID=1 may facilitate signaling in the limited number of bits. Additional bits may not be added to the preamble because full resources (i.e. signaling bits) within the preamble fields may be available for additional features.

11be may have a limited number of bits. The two orthogonal frequency division multiplexing (OFDM) symbols of U-SIG (e.g., U-SIG 110, 210) may not accommodate bits that are contained in this field and some bits may be relegated to “U-SIG overflow bits” carried in the EHT-SIG (e.g., EHT-SIG 112) portion of the preamble. This shortage of available bits may occur when a preamble format may attempt to cover both additional and legacy PPDU modes.

In one example, an access point (AP) may include a processing device. The processing device may generate, at the AP, a transmission including a preamble including a PHY version ID defined by a first IEEE 802.11 standard. The processing device may generate, at the AP, the transmission including the preamble including one or more signaling bits defined by a second IEEE 802.11 standard. The AP may include a transceiver that may send, at the AP to a station (STA), the transmission including the preamble.

In another example, an AP may include a processing device. The processing device may generate, at the AP, a first transmission including a first preamble including a PHY version ID defined by a first IEEE 802.11 standard; and generate, at the AP, a second transmission including a second preamble including a PHY version ID defined by a second IEEE 802.11 standard. The AP may include a transceiver that may send, from the AP to a STA, the first transmission and the second transmission.

The AP may send a transmission that may be an orthogonal frequency division multiple access (OFDM A) transmission that may address one or more STAs using a first IEEE 802.11 standard (e.g., a previous generation standard) and one or more STAs using a second IEEE 802.11 standard (e.g., a later generation standard). More specifically, OFDM A may provide support for IEEE 802.11 be and IEEE 802.11bn.

The preamble may be designed to facilitate mixed use of a previous generation standard (e.g., IEEE 802.11be) and a later generation standard (e.g., 802.11bn in OFDMA). In one example, an OFDM A transmission (e.g., downlink (DL) or uplink (UL)) may address a mix of a previous generation standard (e.g., IEEE 802.11be) and a later generation standard (e.g., IEEE 802.11bn) capable STA s simultaneously. Other mixes of generations may also be used. For example, a previous generation standard such as IEEE 802.11ax may be mixed with a later generation standard such as IEEE 802.11bn.

Addressing previous generation standard STA s and later generation standard STAs may: (1) increase efficiency because different generations (e.g., IEEE 802.11be and IEEE 802.11bn) may not be partitioned into different groups, and (2) facilitate a seamless introduction of a later generation standard (e.g., IEEE 802.11bn) into a legacy standard (e.g., IEEE 802.11be) deployment.

An OFDMA transmission (which may be a DL OFDMA transmission) may have various characteristics. The OFDMA transmission may be processed by earlier generation standard (e.g., IEEE 802.11be) STAs and later generation standard (e.g., IEEE 802.11bn) STAs. The OFDM A transmission may not cause early termination for either generation of STA.

Furthermore, the preamble changes after U-SIG (e.g., U-SIG 110, 210) may be transparent to the earlier generation standard STAs (e.g., IEEE 802.11be STAs). The earlier generation standard STAs (e.g., IEEE 802.11be STAs) may parse the preamble or the portions thereof relevant for the earlier generation STA device. For example, earlier generation standard STAs (e.g., IEEE 802.11be STAs) may see compatible EHT-SIG (e.g., EHT-SIG 112).

The user information fields of the preamble may be the same for the first IEEE 802.11 standard and the second IEEE 802.11 standard. For example, the user information fields may be identical for IEEE 802.11be STAs or IEEE 802.11bn STAs. Alternatively or in addition, an additional IEEE 802.11bn format may be defined for a user information field.

Therefore, ultra high reliability (UHR) may have the ability to address a mix of EHT and UHR STAs in a single OFDM A transmission (which may be UL or DL).

There are various PHY parameters that may be signaled using mixed generation standards. For example, 2× low density parity check (LDPC) and unequal modulation (UEQM) (including MCS) may be signaled.

### LDPC:

Previous PHY generations signaled a binary choice between binary convolutional coding (BCC) or LDPC coding. The codeword size may not be signaled. The codeword size may be determined as a function of code rate, N_{avbits} and N_{pld}. A new entry may be added (L_{LDPC}=3888) as shown in Table 1. When 2×LDPC is not used, then the capability may be indicated in the capabilities element. If both sides support 2×LDPC, then explicit signaling of 2×LDPC may not be used in the preamble.

TABLE 1
PPDU encoding parameters

| | Number of LDPC | LDPC codeword length |
|---|---|---|
| Range of Navbits (bits) | codewords (NCW) | (L_{LDPC}) |
| N_{avbits} ≤ 648 | 1 | 1296, if N_{avbits} ≥ |
| | | N_{pld} + 912(1− R) |
| | | 648 otherwise |
| 648 < N_{avbits} ≤ 1296 | 1 | 1944, if N_{avbits} ≥ |
| | | N_{pld} + 1464(1− R) |
| | | 1296 otherwise |
| 1296 < N_{avbits} ≤ 1944 | 1 | 1944 |
| 1944 < N_{avbits} ≤ 2592 | 2 | 1944 if N_{avbits} ≥ |
| | | N_{pld} + 2916(1− R) |
| | | 1296 otherwise |
| 2592 < N_{avbits} ≤ 3888 | 2 | 1944 |
| 3888 < N_{avbits} | $⌈ \frac{{N}_{pld}}{3 \; 888 R} ⌉$ | 3888 |

### UEQM:

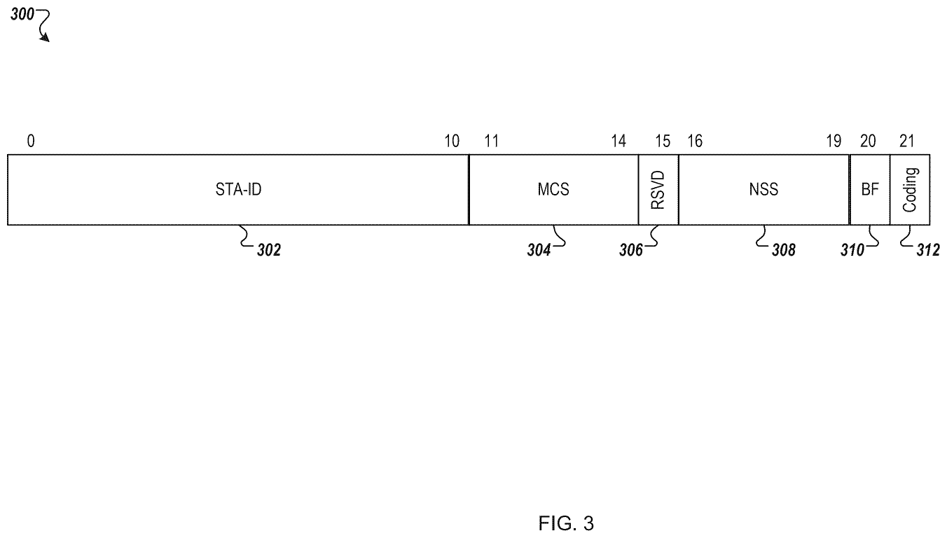

The MCS may be signaled in the user field within the user specific field of e.g., EHT-SIG. An example of the user field 300 for non-MU MIMO is provided in FIG. 3. The user field 300 may include a station identifier (STA-ID) 302, modulation and coding scheme (MCS) bits 304, a reserved bit 306, number of spatial streams (NSS) bits 308, a beamforming (BF) bit 310, and a coding bit 312. According to the user field 300, a reserved bit 306 may be available.

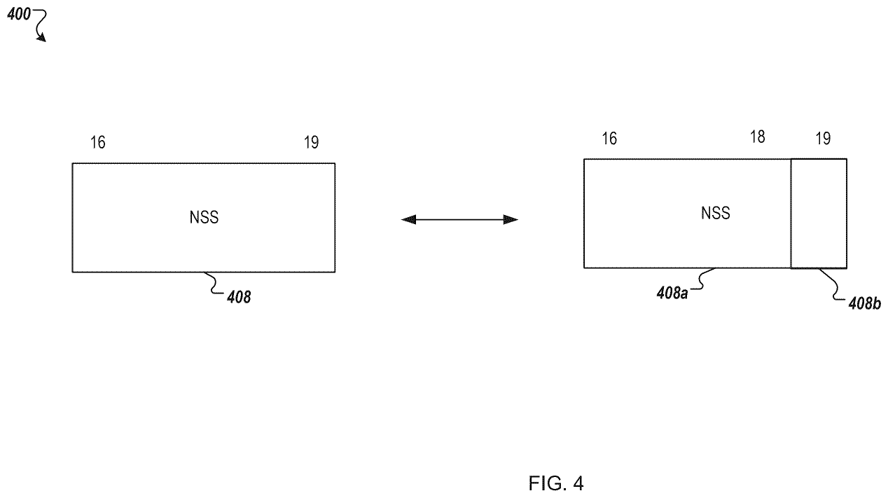

Moreover, as illustrated in the diagram 400 in FIG. 4, while the NSS bits 408 may include 4 bits, values 0-7 are allowed (i.e., other values are validate). Therefore, the NSS bits 408 may provide another de factor reserved bit as shown by the separation of NSS bits 408 into bits 408a and bit 408b. As a result, there may be 2 bits that may be available for additional signaling (i.e., reserved bit 306 and bit 408b).

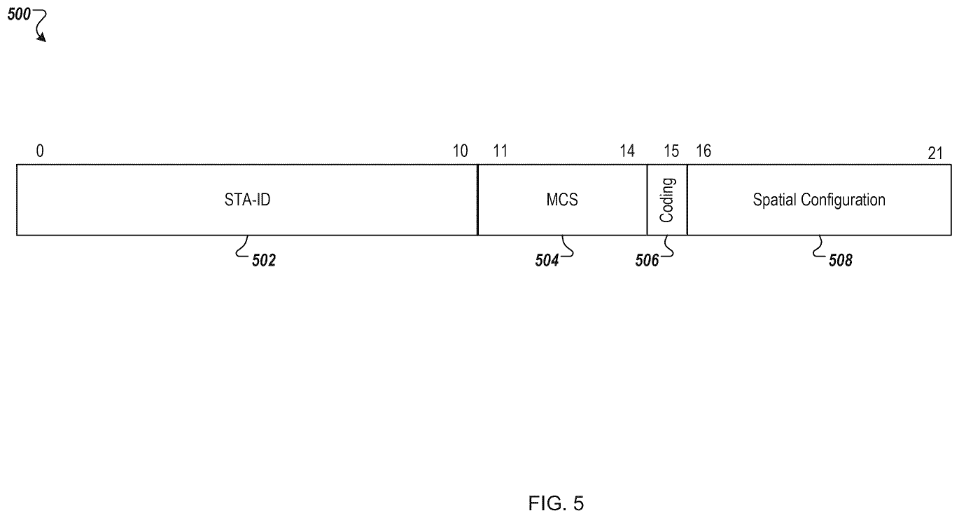

An example of the user field 500 for MU MIMO is provided in FIG. 5. The user field 500 may include a STA-ID 502, MCS bits 504, a coding bit 506, and spatial configuration bits 508. The spatial configuration bits 508 signal at most 13 entries (for Nᵤₛₑᵣ=3). Therefore, the spatial configuration bits 508 include the equivalent of two reserved bits. Therefore, 2 bits may be available for additional signaling.

Unequal modulation may be signaled in the preamble using one or more signaling bits. That is, in either case (non-MU MIMO or MU MIMO) a reserved bit may be used to signal the use of UEQM. When UEQM is used for non-MU MIMO, the 4 MCS bits (B11-14) and 3 NSS bits (B16-18) may be combined to signal up to 128 possible UEQM/NSS variations (7 bits). UEQM may be signaled in the preamble as an entry in a list of defined UEQMs. That is, a lookup table may be defined to map the UEQM N/NSS variations to specific combinations of NSS and MCS. Some NSS values may use more MCS patterns than others. That is, the same number of MCS may not be used for values of NSS, E.g., in IEEE 802.11n:6 UEQM for NSS=2, 14 UEQM for NSS=3, 24 UEQM for NSS=4. An example of a mapping between 7 bits and UEQM variations is provided in Table 2. UEQM may use one or more of binary phase shift keying (BPSK), quadrature phase shift keying (QPSK), 16-quadrature amplitude modulation (16-QAM), 64-quadrature amplitude modulation (64-QAM), or the like.

TABLE 2
Bits mapped to UEQM.

| B11 | B12 | B13 | B14 | B16 | B17 | B18 | UEQM | | |
|---|---|---|---|---|---|---|---|---|---|
| 0 | 0 | 0 | 0 | 0 | 0 | 0 | QPSK | BPSK | ½ |
| 0 | 0 | 0 | 0 | 0 | 0 | 1 | 16 QAM | QPSK | ½ |
| 0 | 0 | 0 | 0 | 0 | 1 | 0 | 16 QAM | QPSK | ¾ |
| 0 | 0 | 0 | 0 | 0 | 1 | 1 | 64 QAM | 16 QAM | ⅔ |

. . .

| | | | | | | | | | | |
|---|---|---|---|---|---|---|---|---|---|---|
| 0 | 0 | 0 | 1 | 0 | 0 | 0 | QPSK | QPSK | BPSK | ½ |
| 0 | 0 | 0 | 1 | 0 | 0 | 1 | 16 QAM | 16 QAM | QPSK | ½ |
| 0 | 0 | 0 | 1 | 0 | 1 | 0 | 16 QAM | 16 QAM | QPSK | ¾ |

. . .

| | | | | | | | | | | | |
|---|---|---|---|---|---|---|---|---|---|---|---|
| 0 | 1 | 0 | 0 | 0 | 0 | 0 | QPSK | QPSK | QPSK | BPSK | ½ |
| 0 | 1 | 0 | 0 | 0 | 0 | 1 | 16 QAM | 16 QAM | 16 QAM | QPSK | ½ |
| 0 | 1 | 0 | 0 | 0 | 1 | 0 | 16 QAM | 16 QAM | 16 QAM | QPSK | ¾ |

. . .

When UEQM is used with MU-MIMO), one of the reserved bits may be used to indicate use of UEQM. The N_{SS} may be signaled as part of the spatial configuration field. For the value of N_{SS}, up to 16 UEQM variations may be signaled in the 4 MCS bits (B11-14). Therefore, the UEQM variations may be mapped to bits in the case of MU-MIMO.

In some examples, the preamble may include an N_{SS} range for the second IEEE 802.11 standard that is greater than or equal to the N_{SS} range for the first IEEE 802.11 standard. For example, the N_{SS} range used for UHR may be equal to the N_{SS} range used for EHT. In addition or alternatively, the preamble may include an MCS range for the second IEEE 802.11 standard that is greater than or equal to the MCS range for the first IEEE 802.11 standard. For example, the MCS range for UHR may be equal to the MCS range for EHT. User Information Field:

Signaling may be accommodated within 22 bits of a user information field. The transmission may revert to a previous generation standard (e.g., IEEE 802.11be) when a later generation standard (e.g., IEEE 802.11bn) is not used. In other words, UHR signaling may revert to EHT signaling when none of the UHR-specific features (e.g., UEQM, additional MCS, 2×LDPC, or the like) are used. Reserved bit(s) may be maintained for future extension.

The UEQM pattern may specify the modulation index over the different streams. For example, base MCS=7 and pattern [M, M, M−1] may correspond to a 3-stream UEQM (64 QAM, 64 QAM, 16 QAM) with code rate 5/6. However, this ignores the fact that many combinations of (Base MCS, UEQM Pattern) may not be in fact valid UEQM. For example, M−1 or M−2 may not be a valid value. Furthermore, M−1, M−2 may not share a code rate with the base MCS. The combinations of base MCS and UEQM pattern may indicate that 162 combinations may be signaled. However, of the 162 possible combinations, 60 may not map to a valid UEQM. For N_{SS}=2, 12 out of the 36 possible combinations may not map to a valid UEQM. For N_{SS}=3, 20 out of the 54 possible combinations may not map to a valid UEQM. For N_{SS}=4, 28 out of the 72 possible combinations may not map to a valid UEQM. Therefore, 102 UEQM may be signaled. Defining UEQM as a (Base MCS, Pattern) combination may be inefficient because it would result in a number of invalid combinations.

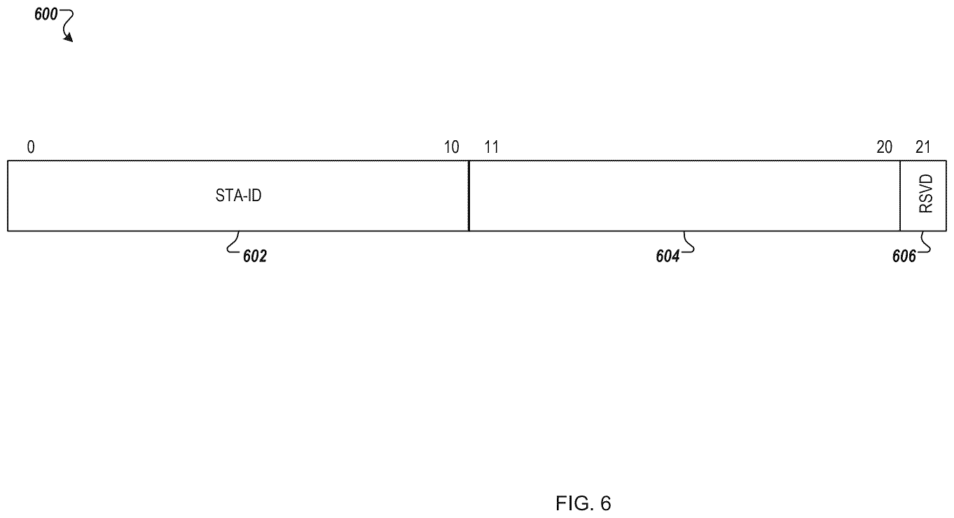

The number of different combinations may include the following: (1) “Legacy” EQM MCS/NSS/BF/Coding combinations: 16×8×2×2=512; (2) Additional MCS/NSS/BF/Coding combinations: 4×8×2×2=128; and (3) UEQM: 102. Therefore, the total number of combinations to be signaled may be 742. Because log 2(742)≈9.5, the information may fit within 10 bits. Assuming the STA-ID field is 11 bits, the information may be encoded in a user information field of 22 bits, which allows one more (reserved) bit available for additional signaling. As illustrated in the diagram 600 in FIG. 6, a STA-ID 602 may fit within bits 0 to 10. A reserved bit 606 may fit within bit 21. Remaining bits 604 (e.g., bits 11-20) may be used for UEQM signaling.

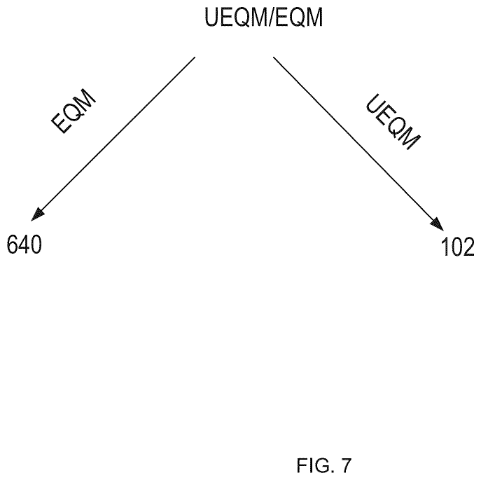

As illustrated in the diagram 700 in FIG. 7, the number of combinations that may be signaled (e.g., 742) may be split into two subjects using 9 bits. However, this results in an unbalanced split of the combinations. The equal modulation (EQM) signaling (640 combinations) may use 10 bits, and therefore a 22-bit user information field may not be maintained.

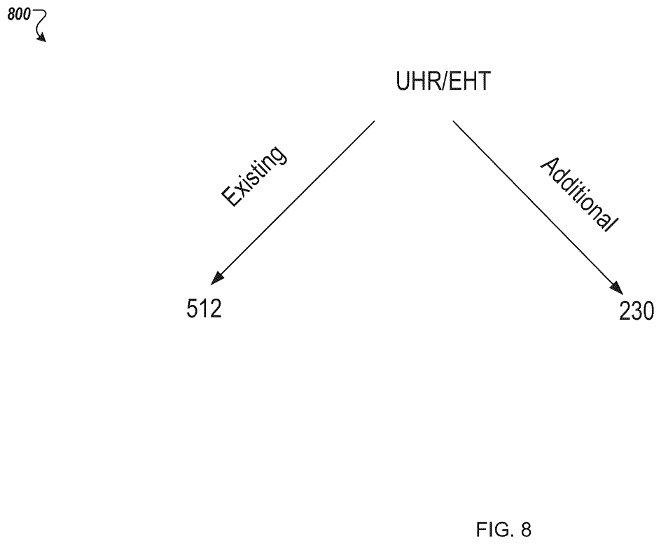

As illustrated in the diagram 800 in FIG. 8, the number of combinations to be signaled (e.g., 742) may be split based on existing MCS (i.e., supported in EHT, or 512 combinations) and additional MCS (i.e., not yet supported in EHT, or 230 combinations). This split allows the subsets to be encoded in 9 bits, achieving the theoretical value of 10 bits for signaling the possible combinations.

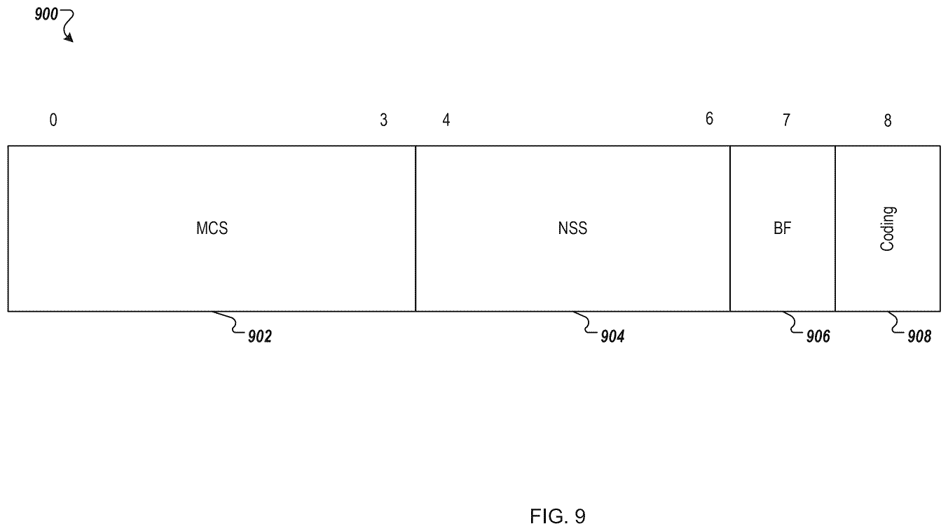

The EHT combinations may be encoded as illustrated in FIG. 9. The 9-bit structure used in EHT may be maintained. The 9 bits may include the following fields: (a) MCS 902 (bits 0 to 3), (b) NSS 904 (bits 4-6), (c) BF 906 (bit 7), and (d) coding 908 (bit 8). This covers MCS up to 8 SS, allowing for BF and coding type indication.

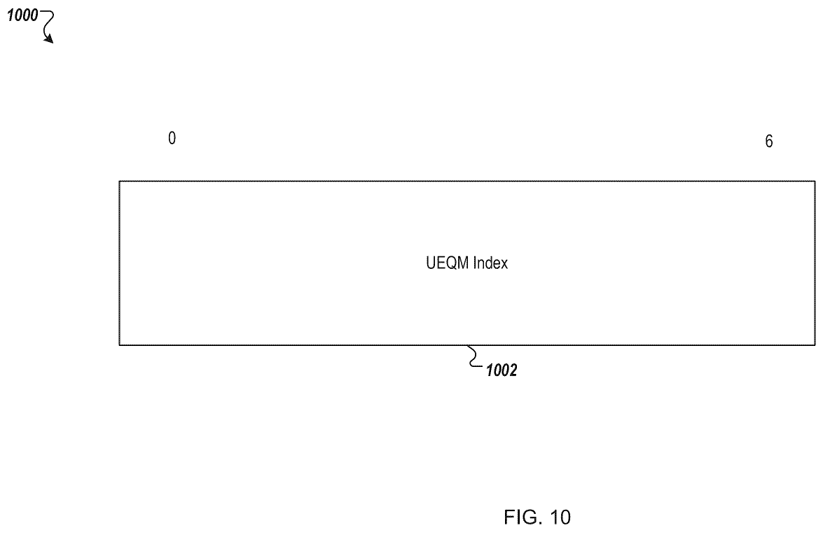

For the additional EQM, the information may be encoded in 7 bits using a similar structure as illustrated in the diagram 1000 in FIG. 10. That is, the MCS may be encoded using bits 0 to 1, the NSS may be encoded using bits 2 to 4, the BF may be encoded using bit 5, and coding may be encoding using bit 6. For the 102 UEQM combinations, the combinations may be referenced as entries in a lookup table-which may use 7 bits. As illustrated in the diagram 1000 in FIG. 10, the UEQM index 1002 may be referenced using bits 0 to 6. Therefore, the 230 additional MCS (which may include additional EQM and additional UEQM) may be combined into 8 bits.

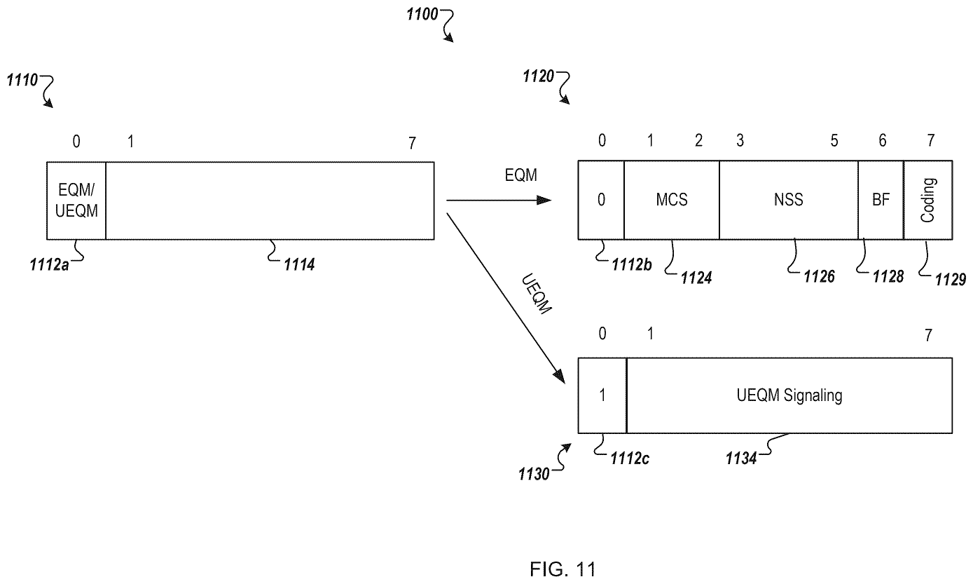

As illustrated in the diagram 1100 in FIG. 11, a bit map 1110 may include an EQM/UEQM bit 1112a and remaining bits 1114 (i.e., bits 1 to 7). When EQM is selected, then bitmap 1120 shows that the EQM bit 1112b may be 0, the MCS bits 1124 may include bits 1 to 2, the NSS bits 1126 may include bits 3 to 5, the BF bit 1128 may include bit 6, and the coding bit 1129 may include bit 7. When UEQM is selected, then bitmap 1130 shows that the UEQM bit 1112c may be 1 and UEQM signaling 1134 may use bits 1 to 7. Therefore, for EQM, encoding fields (MCS, NSS, Coding, BF) may be maintained so that there may be no unused bits (i.e., 7 bits may be used to signal 128 values). For UEQM, the valid UEQM may be listed in a lookup table and the index to the corresponding entry may be coded in U-SIG. Partitioning per NSS may not be used because different NSS values may use a different number of UEQM. Using 7 bits to signal 102 values may be the most efficient way of storing and communicating the information.

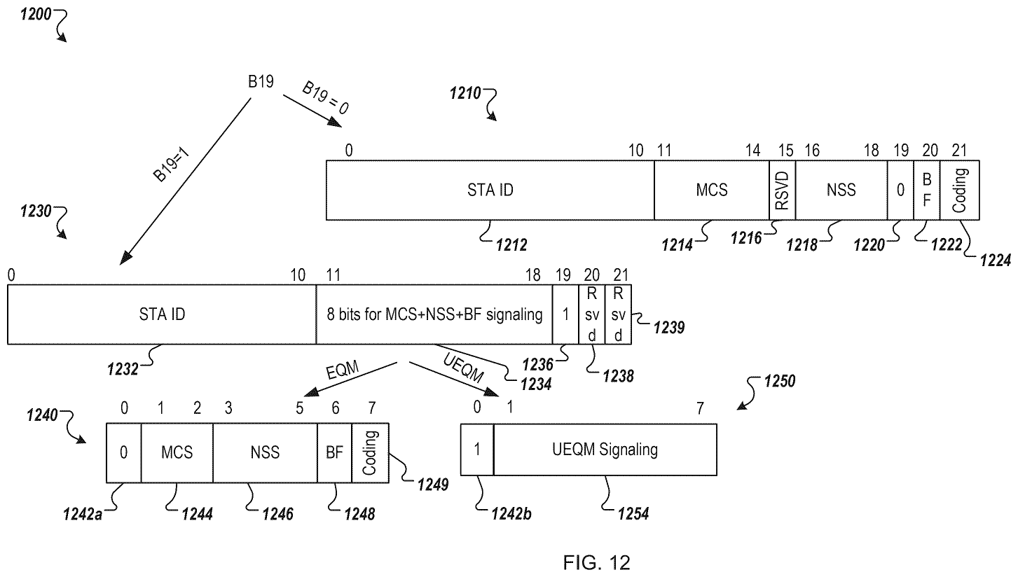

As illustrated in the diagram 1200 in FIG. 12, the 19th bit may be used to select a legacy mode, as shown by bitmap 1210, or an additional MCS mode, as shown by bitmap 1230. The legacy mode may include a STA-ID 1212 (which may use bits 0 to 10), an MCS 1214 (which may use bits 11 to 14), a reserved bit 1216 (which may use bit 15), an NSS 1218, a bit 1220 (which may use the 19^{th} bit), a BF 1222 (which may use bit 20), and a coding bit 1224 (which may use bit 21).

The additional MCS mode, as shown by bitmap 1230 may include a STA ID 1232, bits 1234 used for MCS, N_{SS}, and BF signaling, a bit 1236 (which may use the 19^{th} bit), and reserved bits 1238, 1239. The additional MCS mode may be divided into EQM, as shown by bitmap 1240, or UEQM, as shown by bitmap 1250. Bitmap 1240 may include EQM bit 1242a (which may be 0), MCS bits 1244 (which may include bits 1 and 2), NSS bits 1246 (which may include bits 3 to 5), BF bit 1248 (which may include bit 6), and coding bit 1249 (which may include bit 7). Bitmap 1250 may include UEQM bit 1242b (which may be 1), and UEQM signaling bits 1254 (which may be bits 1 to 7).

As illustrated in FIG. 12, bitmap 1210 may be identical to EHT by design. The data field may be indistinguishable from EHT. Additional modes (e.g., MCS, LDPC, and the like) may be distinguishable from EHT. The additional MCS may be separated in EQM and UEQM. Of the 22 bits, 1 or 2 may have a reserved value. At least one reserved bit may be available for MCS. 1×/2×LPDC CW size may be signaled using a reserved bit. One additional reserved bit may available for additional MCS, which may provide flexibility for future extension.

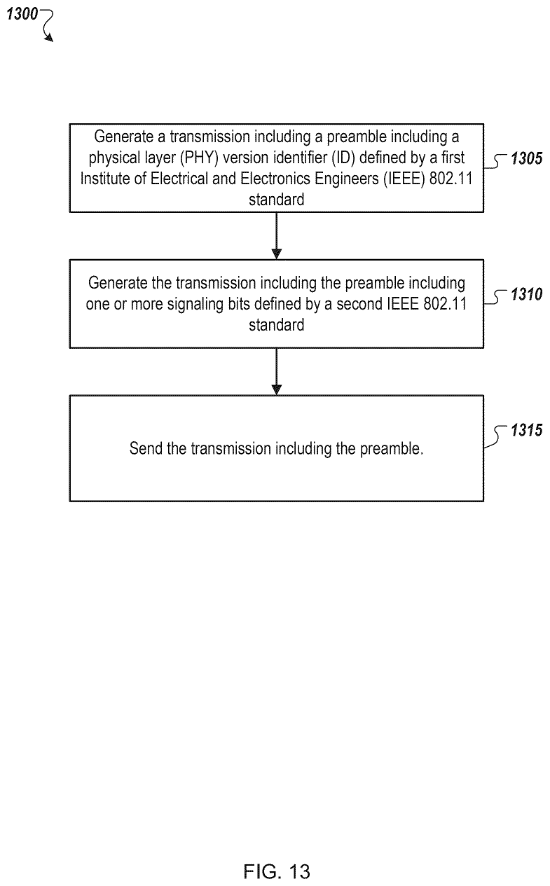

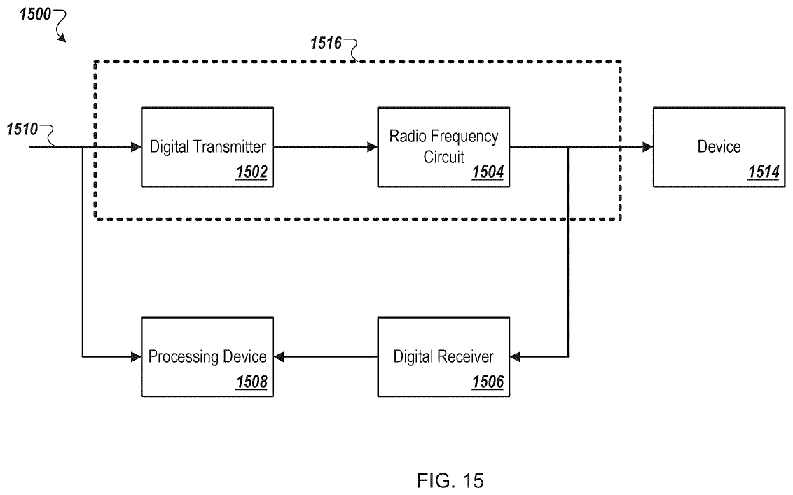

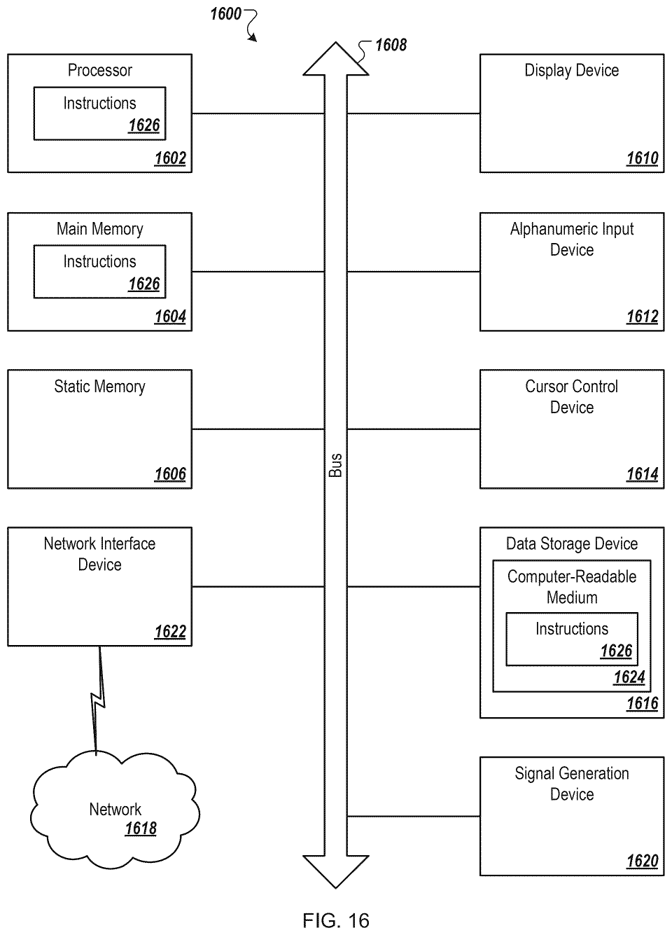

FIG. 13 illustrates a process flow of an example method 1300 of mixed generation preamble transmission, in accordance with at least one example described in the present disclosure. The method 1300 may be arranged in accordance with at least one example described in the present disclosure. The method 1300 may be performed by processing logic that may include hardware (circuitry, dedicated logic, etc.), software (such as is run on a computer system or a dedicated machine), or a combination of both, which processing logic may be included in the processing device 1602 of FIG. 16, the communication system 1500 of FIG. 15, or another device, combination of devices, or systems.

The method 1300 may begin at block 1305 where the processing logic may generate, at the AP, a transmission including a preamble including a PHY version ID defined by a first IEEE 802.11 standard.

At block 1310, the processing logic may generate, at the AP, the transmission including the preamble including one or more signaling bits defined by a second IEEE 802.11 standard.

At block 1315, the processing logic may send, at the AP to a station (STA), the transmission including the preamble.

Modifications, additions, or omissions may be made to the method 1300 without departing from the scope of the present disclosure. For example, in some examples, the method 1300 may include any number of other components that may not be explicitly illustrated or described.

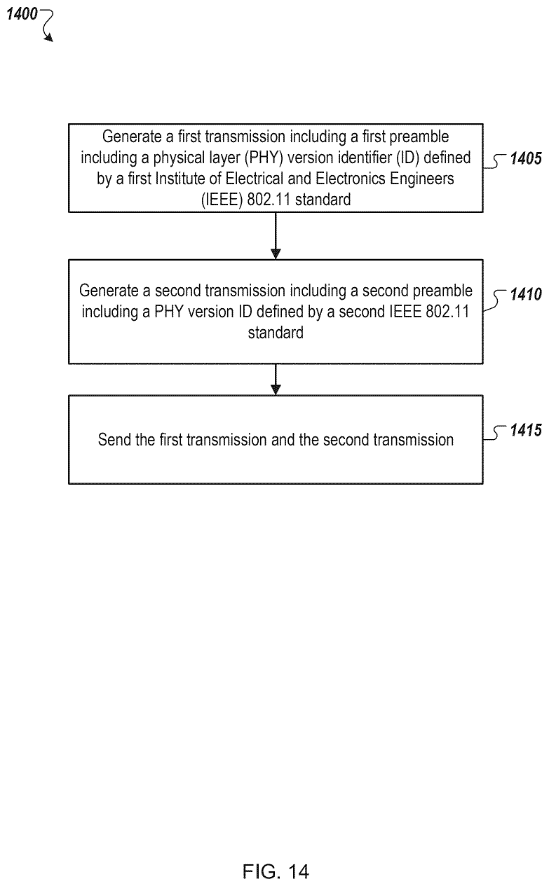

FIG. 14 illustrates a process flow of an example method 1400 that may be used for mixed generation preamble transmission, in accordance with at least one example described in the present disclosure. The method 1400 may be arranged in accordance with at least one example described in the present disclosure.

The method 1400 may be performed by processing logic that may include hardware (circuitry, dedicated logic, etc.), software (such as is run on a computer system or a dedicated machine), or a combination of both, which processing logic may be included in the processing device 1602 of FIG. 16, the communication system 1500 of FIG. 15, or another device, combination of devices, or systems.

The method 1400 may begin at block 1405 where the processing logic may generate, at the AP, a first transmission including a first preamble including a PHY version ID defined by a first IEEE 802.11 standard.

At block 1410, the processing logic may generate, at the AP, a second transmission including a second preamble including a PHY version ID defined by a second IEEE 802.11 standard.

At block 1415, the processing logic may send, from the AP to a STA, the first transmission and the second transmission.

Modifications, additions, or omissions may be made to the method 1400 without departing from the scope of the present disclosure. For example, in some examples, the method 1400 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 15 illustrates a block diagram of an example communication system 1500 for mixed generation preamble transmission, in accordance with at least one example described in the present disclosure. The communication system 1500 may include a digital transmitter 1502, a radio frequency circuit 1504, a device 1514, a digital receiver 1506, and a processing device 1508. The digital transmitter 1502 and the processing device may receive a baseband signal via connection 1510. A transceiver 1516 may include the digital transmitter 1502 and the radio frequency circuit 1504.

In some examples, the communication system 1500 may include a system of devices that may communicate with one another via a wired or wireline connection. For example, a wired connection in the communication system 1500 may include one or more Ethernet cables, one or more fiber-optic cables, and/or other similar wired communication mediums. Alternatively, or additionally, the communication system 1500 may include a system of devices that may communicate via one or more wireless connections. For example, the communication system 1500 may include one or more devices that may transmit and/or receive radio waves, microwaves, ultrasonic waves, optical waves, electromagnetic induction, and/or similar wireless communications. Alternatively, or additionally, the communication system 1500 may include combinations of wireless and/or wired connections. In these and other examples, the communication system 1500 may include one or more devices that may obtain a baseband signal, perform one or more operations to the baseband signal to generate a modified baseband signal, and transmit the modified baseband signal, such as to one or more loads.

In some examples, the communication system 1500 may include one or more communication channels that may communicatively couple systems and/or devices included in the communication system 1500. For example, the transceiver 1516 may be communicatively coupled to the device 1514.

In some examples, the transceiver 1516 may obtain a baseband signal. For example, as described herein, the transceiver 1516 may generate a baseband signal and/or receive a baseband signal from another device. In some examples, the transceiver 1516 may transmit the baseband signal. For example, upon obtaining the baseband signal, the transceiver 1516 may transmit the baseband signal to a separate device, such as the device 1514. Alternatively, or additionally, the transceiver 1516 may modify, condition, and/or transform the baseband signal in advance of transmitting the baseband signal. For example, the transceiver 1516 may include a quadrature up-converter and/or a digital to analog converter (DA C) that may modify the baseband signal. Alternatively, or additionally, the transceiver 1516 may include a direct radio frequency (RF) sampling converter that may modify the baseband signal.

In some examples, the digital transmitter 1502 may obtain a baseband signal via connection 1510. In some examples, the digital transmitter 1502 may up-convert the baseband signal. For example, the digital transmitter 1502 may include a quadrature up-converter to apply to the baseband signal. In some examples, the digital transmitter 1502 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 1502.

In some examples, the transceiver 1516 may include one or more subcomponents that may be used in preparing the baseband signal and/or transmitting the baseband signal. For example, the transceiver 1516 may include an RF front end (e.g., in a wireless environment) which may include a power amplifier (PA), a digital transmitter (e.g., 1502), a digital front end, an IEEE 1588v2 device, a Long-Term Evolution (LTE) physical layer (L-PHY), an (S-plane) device, a management plane (M-plane) device, an Ethernet media access control (M A C)/personal communications service (PCS), a resource controller/scheduler, and the like. In some examples, a radio (e.g., a radio frequency circuit 1504) of the transceiver 1516 may be synchronized with the resource controller via the S-plane device, which may contribute to high-accuracy timing with respect to a reference clock.

In some examples, the transceiver 1516 may obtain the baseband signal for transmission. For example, the transceiver 1516 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 1516 may generate a baseband signal for transmission. In these and other examples, the transceiver 1516 may transmit the baseband signal to another device, such as the device 1514.

In some examples, the device 1514 may receive a transmission from the transceiver 1516. For example, the transceiver 1516 may transmit a baseband signal to the device 1514.

In some examples, the radio frequency circuit 1504 may transmit the digital signal received from the digital transmitter 1502. In some examples, the radio frequency circuit 1504 may transmit the digital signal to the device 1514 and/or the digital receiver 1506. In some examples, the digital receiver 1506 may receive a digital signal from the RF circuit and/or send a digital signal to the processing device 1508.

In some examples, the processing device 1508 may be a standalone device or system, as illustrated. Alternatively, or additionally, the processing device 1508 may be a component of another device and/or system. For example, in some examples, the processing device 1508 may be included in the transceiver 1516. In instances in which the processing device 1508 is a standalone device or system, the processing device 1508 may communicate with additional devices and/or systems remote from the processing device 1508, such as the transceiver 1516 and/or the device 1514. For example, the processing device 1508 may send and/or receive transmissions from the transceiver 1516 and/or the device 1514. In some examples, the processing device 1508 may be combined with other elements of the communication system 1500.

FIG. 16 illustrates a diagrammatic representation of a machine in the example form of a computing device 1600 within which a set of instructions, for causing the machine to perform any one or more of the methods discussed herein, may be executed. The computing device 1600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1600 includes a processing device (e.g., a processor 1602), a main memory 1604 (e.g., read-only memory (ROM), flash memory, dynamic random access memory (DRAM) such as synchronous DRAM (SDRAM)), a static memory 1606 (e.g., flash memory, static random access memory (SRAM)) and a data storage device 1616, which communicate with each other via a bus 1608.

Processing device 1602 represents one or more general-purpose processing devices such as a microprocessor, central processing unit, or the like. More particularly, the processing device 1602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1602 may also include one or more special-purpose processing devices such as an application specific integrated circuit (A SIC), a field programmable gate array (FPGA), a digital signal processor (DSP), network processor, or the like. The processing device 1602 is configured to execute instructions 1626 for performing the operations and steps discussed herein.

The computing device 1600 may further include a network interface device 1622 which may communicate with a network 1618. The computing device 1600 also may include a display device 1610 (e.g., a liquid crystal display (LCD) or a cathode ray tube (CRT)), an alphanumeric input device 1612 (e.g., a keyboard), a cursor control device 1614 (e.g., a mouse) and a signal generation device 1620 (e.g., a speaker). In at least one example, the display device 1610, the alphanumeric input device 1612, and the cursor control device 1614 may be combined into a single component or device (e.g., an LCD touch screen).

The data storage device 1616 may include a computer-readable storage medium 1624 on which is stored one or more sets of instructions 1626 embodying any one or more of the methods or functions described herein. The instructions 1626 may also reside, completely or at least partially, within the main memory 1604 and/or within the processing device 1602 during execution thereof by the computing device 1600, the main memory 1604 and the processing device 1602 also constituting computer-readable media. The instructions may further be transmitted or received over a network 1618 via the network interface device 1622.

While the computer-readable storage medium 1624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
generate, at the AP, a transmission including a preamble including a physical layer (PHY) version identifier (ID) defined by a first Institute of Electrical and Electronics Engineers (IEEE) 802.11 standard; and
generate, at the AP, the transmission including the preamble including one or more signaling bits defined by a second IEEE 802.11 standard; and
a transceiver operable to:
send, at the AP to a station (STA), the transmission including the preamble.

2. The AP of claim 1, wherein the transmission is an orthogonal frequency division multiple access (OFDM A) transmission operable to address one or more STA s using the first IEEE 802.11 standard and one or more STAs using the second IEEE 802.11 standard.

3. The AP of claim 1, wherein user information fields of the preamble are the same for the first IEEE 802.11 standard and the second IEEE 802.11 standard.

4. The AP of claim 1, wherein the preamble includes:
a number of spatial streams (N_{SS}) range for the second IEEE 802.11 standard that is greater than or equal to the N_{SS} range for the first IEEE 802.11 standard; or
a modulation and coding scheme (MCS) range for the second IEEE 802.11 standard that is greater than or equal to the MCS range for the first IEEE 802.11 standard.

5. The AP of claim 1, wherein unequal modulation is signaled in the preamble using the one or more signaling bits.

6. The AP of claim 1, wherein unequal modulation (UEQM) is signaled in the preamble as an entry in a list of defined UEQMs.

7. The AP of claim 1, wherein the transmission reverts to first IEEE 802.11 standard signaling when second IEEE 802.11 standard signaling is not used.

8. An access point (AP), comprising:
a processing device operable to:
generate, at the AP, a first transmission including a first preamble including a physical layer (PHY) version identifier (ID) defined by a first Institute of Electrical and Electronics Engineers (IEEE) 802.11 standard; and
generate, at the AP, a second transmission including a second preamble including a PHY version ID defined by a second IEEE 802.11 standard; and
a transceiver operable to:
send, from the AP to a STA, the first transmission and the second transmission.

9. The AP of claim 8, wherein the first transmission is an orthogonal frequency division multiple access (OFDM A) transmission that is operable to address one or more STAs using the first IEEE 802.11 standard and one or more STA s using the second IEEE 802.11 standard.

10. The AP of claim 8, wherein the second transmission is an orthogonal frequency division multiple access (OFDM A) transmission that is operable to address one or more STAs using the first IEEE 802.11 standard and one or more STAs using the second IEEE 802.11 standard.

11. The AP of claim 8, wherein user information fields of the preamble are the same for the first IEEE 802.11 standard and the second IEEE 802.11 standard.

12. The AP of claim 8, wherein one or more of the first preamble or the second preamble includes:
a number of spatial streams (N_{SS}) range for the second IEEE 802.11 standard that is greater than or equal to the N_{SS} range for the first IEEE 802.11 standard; or
a modulation and coding scheme (MCS) range for the second IEEE 802.11 standard that is greater than or equal to the MCS range for the first IEEE 802.11 standard.

13. The AP of claim 8, wherein unequal modulation is signaled using one or more signaling bits that are defined using the second IEEE 802.11 standard.

14. The AP of claim 8, wherein the second transmission reverts to the first IEEE 802.11 standard signaling when second IEEE 802.11 standard signaling is not used.

15. An access point (AP), comprising:
a processing device operable to:
receive, at the AP from a first station, a transmission including a preamble including a physical layer (PHY) version identifier (ID) defined by a first Institute of Electrical and Electronics Engineers (IEEE) 802.11 standard, wherein the preamble includes one or more signaling bits defined by a second IEEE 802.11 standard.

16. The AP of claim 15, wherein the transmission is an orthogonal frequency division multiple access (OFDM A) transmission.

17. The AP of claim 15, wherein user information fields of the preamble are the same for the first IEEE 802.11 standard and the second IEEE 802.11 standard.

18. The AP of claim 15, wherein unequal modulation is signaled in the preamble using the one or more signaling bits.

19. The AP of claim 15, wherein unequal modulation (UEQM) is signaled in the preamble as an entry in a list of defined UEQM s.

20. The AP of claim 15, wherein the transmission reverts to first IEEE 802.11 standard signaling when second IEEE 802.11 standard signaling is not used.
